(19) United States
(12) Patent Application Publication
(10) Pub. No.: US 2024/0194102 A1
(43) Pub. Date: Jun. 13, 2024

(54) DISPLAY DEVICE AND METHOD OF DRIVING SAME

(71) Applicant: LG DISPLAY CO., LTD., Seoul (KR)

(72) Inventor: Se Ho LIM, Paju-si (KR)

(73) Assignee: LG DISPLAY CO., LTD., SEOUL (KR)

(21) Appl. No.: 18/388,205

(22) Filed: Nov. 9, 2023

(30) Foreign Application Priority Data
Dec. 12, 2022 (KR) 10-2022-0172851

(51) Int. Cl. G09G 3/00; G09G 3/20; G09G 3/3233

(52) U.S. Cl. CPC G09G 3/006; G09G 3/2007; G09G 3/2096; G09G 3/3233; G09G 2300/0842; G09G 2320/045; G09G 2330/021; G09G 2330/12

(57) ABSTRACT

The present disclosure provides a display device including a display panel configured to display an image, a stress data generator configured to generate stress data corresponding to a data signal to be displayed on the display panel, and a data processor configured to accumulate and store the stress data in a first memory and to compress the accumulated stress data when a capacity of the accumulated stress data exceeds an internally set memory allocation amount.

### CROSS-REFERENCE TO RELATED APPLICATIONS

This application claims the benefit of Korean Patent Application No. 10-2022-0172851, filed on Dec. 12, 2022, which is hereby incorporated by reference as if fully set forth herein.

### BACKGROUND

### Field of the Disclosure

The present disclosure relates to a display device and a method of driving the same.

As information technology develops, the market for display devices, which are communication media between users and information, is growing. Accordingly, display devices such as a light emitting display (LED) device, a quantum dot display (QDD) device, and a liquid crystal display (LCD) device are increasingly used.

The display devices described above include a display panel including sub-pixels, a driver outputting driving signals for driving the display panel, and a power supply for generating power to be supplied to the display panel or the driver.

In such display devices, when driving signals, for example, a scan signal and a data signal, are supplied to sub-pixels formed in a display panel, selected sub-pixels transmit light or directly emit light, thereby displaying an image.

### SUMMARY

Accordingly, the present disclosure is directed to a display device and a method of driving the same that substantially obviate one or more problems due to limitations and disadvantages of the related art.

The present disclosure provides a compensation method capable of improving compensation performance of a display panel by minimizing a risk of compression loss accumulation, enables rapid operation of a display device and decreases a power consumption rate by reducing requirements for generation of a sequence that unnecessarily occurs during data accumulation compensation.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as disclosed herein, a display device includes a display panel configured to display an image, a stress data generator configured to generate stress data corresponding to a data signal to be displayed on the display panel, and a data processor configured to accumulate and store the stress data in a first memory and compress the accumulated stress data when a capacity of the accumulated stress data exceeds an allocated memory threshold corresponding to an allocated amount of memory that is internally set.

The data processor may store the accumulated stress data in the first memory in an uncompressed state when the capacity of the accumulated stress data does not exceed the memory threshold.

The data processor may store the accumulated stress data in a second memory different from the first memory in a compressed state when the capacity of the accumulated stress data exceeds the memory threshold.

The data processor may include a data restorer configured to decompress previous compressed and accumulated stress data in a compressed state read from the second memory to obtain previous accumulated stress data, a data accumulator configured to accumulate the stress data to be stored in the first memory to obtain current accumulated stress data and to integrate the previous accumulated stress data and the current accumulated stress data, and a data compressor configured to compress the integrated previous accumulated stress data and current accumulated stress data to obtain a sum of current compressed and accumulated stress data.

The data processor may decompress previous compressed and accumulated stress data read from the second memory to obtain previous accumulated stress data, read current accumulated stress data obtained by accumulating the stress data from the first memory, integrate and compress the previous accumulated stress data and the current accumulated stress data to obtain a sum of current compressed and accumulated stress data, and then store the sum of the current compressed and accumulated stress data in the second memory.

When the capacity of the accumulated stress data exceeds the memory threshold, the data processor may read the current accumulated stresses excluding an excess from the first memory.

When the capacity of the accumulated stress data exceeds the internally set memory allocation amount, the data processor may read the current accumulated stresses including the excess from the first memory.

In another aspect of the present disclosure, a method of driving a display device includes generating stress data corresponding to a data signal to be displayed on a display panel, storing accumulated stress data obtained by accumulating the stress data in a first memory, determining whether a capacity of the accumulated stress data exceeds a memory threshold, and compressing the accumulated stress data when the capacity of the accumulated stress data exceeds the internally set memory allocation amount.

The accumulated stress data may be stored in the first memory in an uncompressed state when the capacity of the accumulated stress data does not exceed the memory threshold and may be stored in a second memory different from the first memory in a compressed state when the capacity of the accumulated stress data exceeds the internally set memory allocation amount.

When the capacity of the accumulated stress data exceeds the internally set memory allocation amount, the accumulated stress data excluding or including an excess may be read from the first memory.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate aspect (s) of the disclosure and together with the description serve to explain the principle of the disclosure. In the drawings:

FIG. 1 is a schematic block diagram of a light emitting display device:

FIG. 2 is a schematic configuration diagram of a sub-pixel shown in FIG. 1:

FIGS. 3 and 4 are diagrams for describing the configuration of a gate-in-panel type scan driver:

FIG. 5 is a diagram illustrating an example of arrangement of the gate-in-panel type scan driver:

FIG. 6 is a diagram illustrating a first example of a sub-pixel, and

FIG. 7 is a diagram illustrating a second example of a sub-pixel:

FIG. 8 is a circuit diagram for implementing a data accumulation compensation method according to an aspect,

FIG. 9 is a flowchart for describing data backup generation conditions in the data accumulation compensation method according to an aspect,

FIG. 10 is a data accumulation sequence for showing a data accumulation process in connection with a circuit in accordance with some aspects of the disclosure,

FIG. 11 is a block diagram for describing a stress data generation circuit that may be considered in data accumulation in accordance with some aspects of the disclosure, and

FIG. 12 is a block diagram for describing a data counting method that may be considered in data accumulation in accordance with some aspects of the disclosure:

FIG. 13 is a flowchart for describing a data backup process in a data accumulation compensation method in accordance with some aspects of the disclosure, and

FIG. 14 is a data backup sequence showing the data backup process with a circuit in accordance with some aspects of the disclosure: and

FIG. 15 is a diagram for describing differences between a data accumulation compensation method according to a comparative example and the data accumulation compensation method in accordance with some aspects of the disclosure: and

FIG. 16 is a diagram showing a flow of a power-on sequence changed by the data accumulation compensation method in accordance with some aspects of the disclosure.

### DETAILED DESCRIPTION

Reference will now be made in detail to the preferred embodiments of the present disclosure, examples of which are illustrated in the accompanying drawings. Wherever possible, the same reference numbers will be used throughout the drawings to refer to the same or like parts.

A display device according to the present disclosure may be implemented as a television system, an image player, a personal computer (PC), a home theater, an automobile electric device, a smartphone, or the like, but is not limited thereto. The display device according to the present disclosure may be implemented as a light emitting display (LED) device, a quantum dot display (QDD) device, a liquid crystal display (LCD) device, or the like. However, for convenience of description, a light emitting display device that directly emits light based on inorganic light emitting diodes or organic light emitting diodes will be described below:

In addition, a thin film transistor which will be described below may be implemented as an n-type thin film transistor, a p-type thin film transistor, or a combination of n-type and p-type thin film transistors. A thin film transistor is a three-electrode device including a gate, a source, and a drain. The source is an electrode that supplies carriers to the transistor. In a thin film transistor, carriers flow from the source to the drain. The drain is an electrode through which carriers exit the thin film transistor. That is, carriers flow from the source to the drain in the thin film transistor.

In the case of a p-type thin film transistor, the carriers are holes, and thus a source voltage is higher than a drain voltage such that holes may flow from the source to the drain. In a p-type thin film transistor, since holes flow from the source to the drain, current flows from the source to the drain. In the other hand, in the case of an n-type thin film transistor, electrons are carriers, and thus a source voltage is lower than a drain voltage such that electrons may flow from the source to the drain. Since electrons flow from the source to the drain in the n-type thin film transistor, current flows from the drain to the source. However, the source and the drain of the thin film transistor may change depending on an applied voltage. Accordingly, in the following description, one of the source and the drain will be described as a first electrode, and the other will be described as a second electrode.

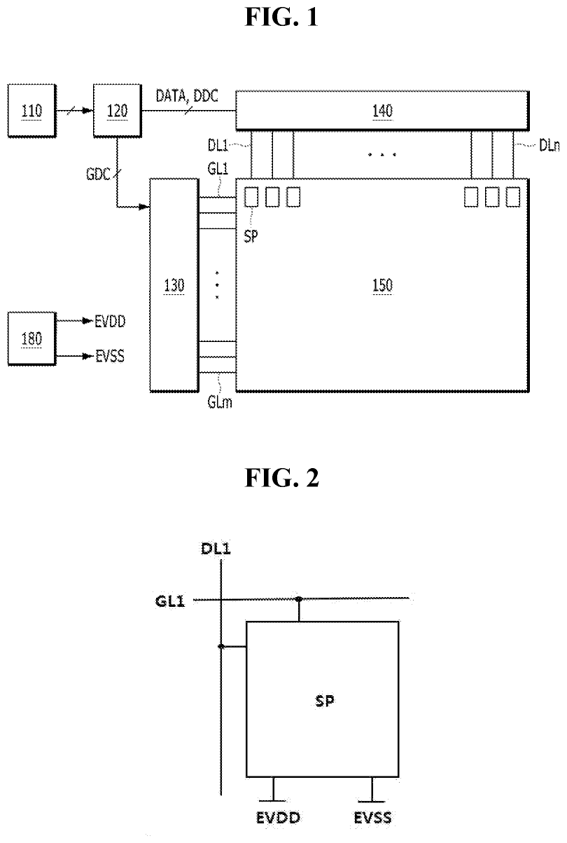

FIG. 1 is a schematic block diagram of a light emitting display device and FIG. 2 is a schematic configuration diagram of a sub-pixel shown in FIG. 1.

As illustrated in FIGS. 1 and 2, the light emitting display device may include an image provider 110, a timing controller 120, a scan driver 130, a data driver 140, a display panel 150, a power supply 180, and the like.

The image provider 110 (e.g., a set or a host system) may output various driving signals together with an externally supplied image data signal or an image data signal stored in an internal memory. The image provider 110 may supply data signals and various driving signals to the timing controller 120.

The timing controller 120 may output a gate timing control signal GDC to control the operation of the scan driver 130, a data timing control signal DDC to control the operation of the data driver 140, and various synchronization signals (a vertical synchronization signal Vsync, a horizontal synchronization signal Hsync, and the like). The timing controller 120 may supply a data signal DATA from the image provider 110 to the data driver 140 together with the data timing control signal DDC. The timing controller 120 may be an integrated circuit (IC) and mounted on a printed circuit board, but is not limited thereto.

The scan driver 130 may output a scan signal in response to the gate timing control signal GDC from the timing controller 120. The scan driver 130 may supply scan signals to sub-pixels SP included in the display panel 150 through gate lines GLI to GLm. The scan driver 130 may be an IC or directly formed on the display panel 150 in a gate-in-panel structure, but is not limited thereto.

The data driver 140 may sample and latch the data signal DATA in response to the data timing control signal DDC from the timing controller 120, convert the digital data signal into an analog data voltage on the basis of a gamma reference voltage, and output the analog data voltage. The data driver 140 may supply data voltages to the sub-pixels SP included in the display panel 150 through data lines DLI to DLn. The data driver 140 may be an IC and mounted on the display panel 150 or mounted on a printed circuit board, but is not limited thereto.

The power supply 180 may generate a first driving voltage at a high level and a second driving voltage at a low level based on an external input voltage from the outside, and output the same through a first driving voltage line EVDD and a second driving voltage line EVSS. The power supply 180 may generate and output voltages (e.g., a gate voltage including a gate high voltage and a gate low voltage) necessary to drive the scan driver 130 and voltages (e.g., a drain voltage including a drain voltage and a half drain voltage) necessary to drive the data driver 140 as well as the first driving voltage and the second driving voltage.

The display panel 150 may display an image in response to driving signals including a scan signal and a data voltage, the first voltage, and the second voltage. The sub-pixels of the display panel 150 may directly emit light. The display panel 150 may be manufactured based on a substrate having rigidity or flexibility. Non-limiting examples of a substrate include glass, silicon, polyimide, or the like. In addition, the sub-pixels that emit light may include red, green, and blue pixels or include red, green, blue, and white pixels.

Meanwhile, in the above description, the timing controller 120, the scan driver 130, the data driver 140, and the like are described as individual components for purposes of illustration. In some cases, depending on the implementation method of the light emitting display device, one or more of the timing controller 120, the scan driver 130, and the data driver 140 may be integrated into a single IC.

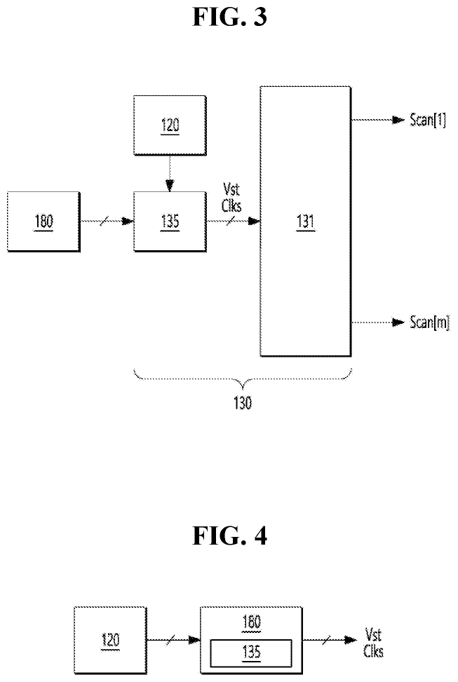

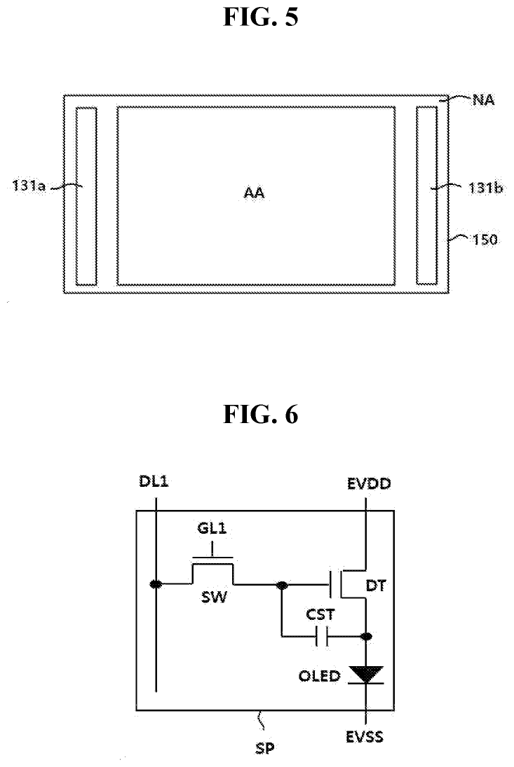

FIGS. 3 and 4 are diagrams for describing the configuration of a gate-in-panel type scan driver, and FIG. 5 is a diagram illustrating an example of arrangement of the gate-in-panel type scan driver.

As illustrated in FIG. 3, the gate-in-panel type scan driver 130 may include a shift register 131 and a level shifter 135. The level shifter 135 may generate scan clock signals Clks and a start signal Vst based on signals and voltages output from the timing controller 120 and the power supply 180.

The shift register 131 receives on the signals Clks and Vst from the level shifter 135 and outputs scan signals Scan[1] to Scan[m] for turning on or off transistors formed in the display panel. The shift register 131 may be formed as a thin film on the display panel in a gate-in-panel structure.

As illustrated in FIGS. 3 and 4, unlike the shift register 131, the level shifter 135 may be independently configured as an IC or may be included in the power supply 180. However, this is merely an example and the present disclosure is not limited thereto.

As illustrated in FIG. 5, shift registers 131a and 131b may be disposed in the non-display area NA of the display panel 150 and are configured to output scan signals in the gate-in-panel type scan driver. The shift registers 131a and 131b may be disposed in upper and lower non-display areas NA of the display panel 150 and may also be divided and disposed within the display area AA of the display panel 150.

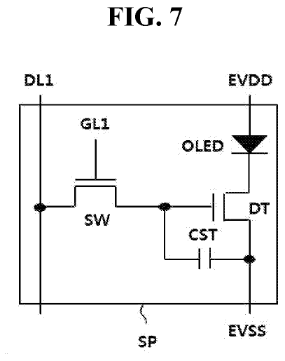

FIG. 6 is a diagram illustrating a first example of a sub-pixel, and FIG. 7 is a diagram illustrating a second example of a sub-pixel.

As illustrated in FIGS. 6 and 7, the sub-pixel may include a switching transistor SW, a driving transistor DT, a capacitor CST, and an organic light emitting diode (OLED).

The switching transistor SW may transfer a data voltage applied through the first data line DLI to a first electrode of the capacitor CST. The capacitor CST may store a data voltage for driving the driving transistor DT. The driving transistor DT may generate a driving current in response to the data voltage stored in the capacitor CST. The organic light emitting diode OLED may emit light in response to the operation (driving current) of the driving transistor DT.

Sub-pixels may be divided into a common cathode structure (e.g., as shown in FIG. 6) and a common anode structure (e.g., as shown in FIG. 7) according to the connection structure of the organic light emitting diode OLED. According to the common cathode structure in FIG. 6, the organic light emitting diode OLED may have an anode connected to the second electrode of the driving transistor DT and a cathode connected to the second power line EVSS. According to the common anode structure in FIG. 7, the organic light emitting diode OLED may have an anode connected to the first power line EVDD and a cathode connected to the first electrode of the driving transistor DT.

A data accumulation compensation method may be used for the sub-pixels shown in FIGS. 6 and 7. The data accumulation compensation method predicts the characteristics (e.g., the amount of deterioration) of elements such as the organic light emitting diode OLED and the driving transistor DT based on an input data signal and compensates for the data signal based on prediction results. For example, the data accumulation compensation method compensates for OLED afterimage and DT deterioration).

Examples of timing at which the organic light emitting diode OLED and the driving transistor DT are compensated may include a time after a user applies power to the display device and does not use the display device (including a screen save period), and a time after turning off the display device, but the present disclosure is not limited thereto.

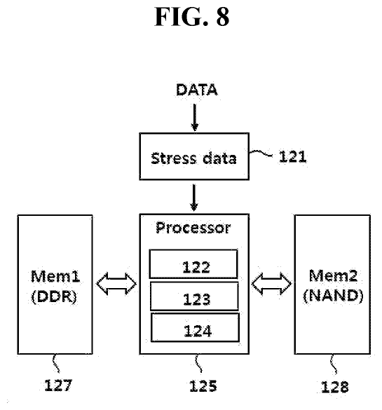

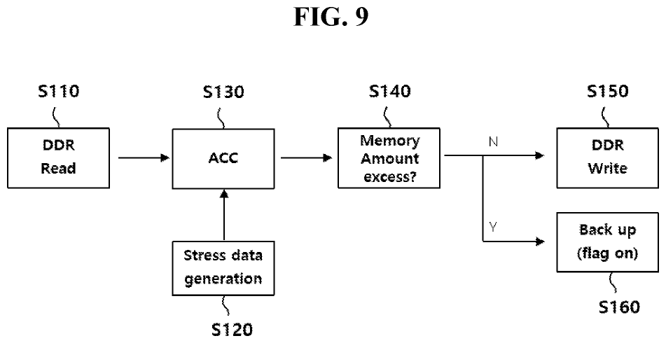

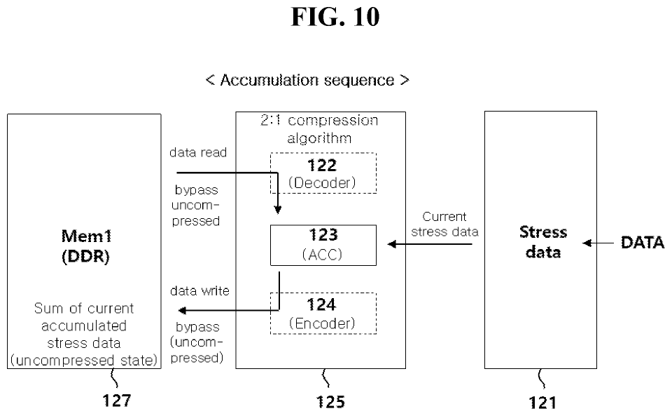

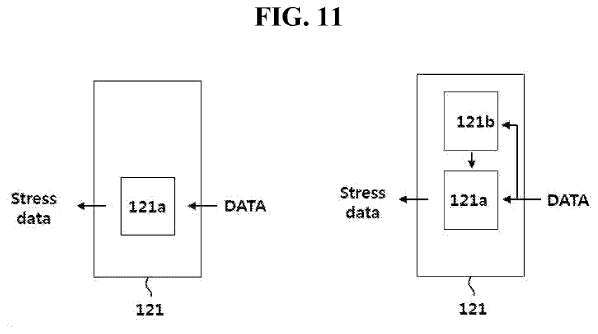

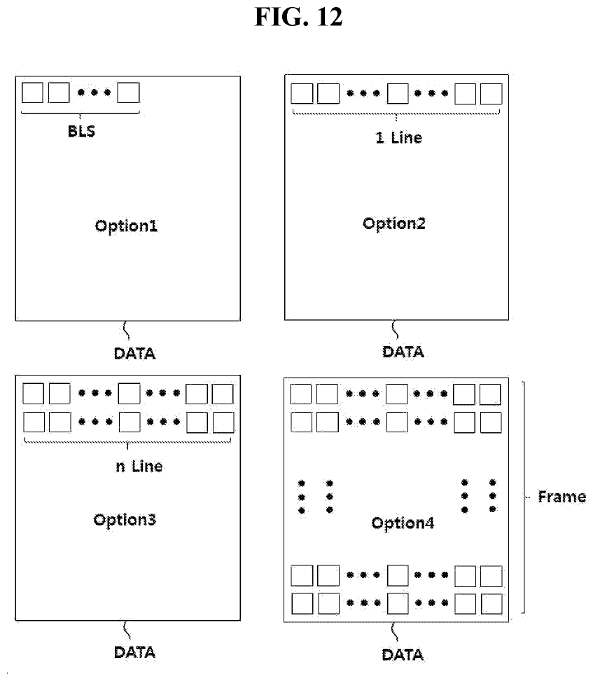

FIG. 8 is a circuit diagram for implementing a data accumulation compensation method according to an aspect. FIG. 9 is a flowchart for describing data backup generation conditions in the data accumulation compensation method according to an aspect. FIG. 10 is a data accumulation sequence for showing a data accumulation process in connection with a circuit in accordance with some aspects of the disclosure. FIG. 11 is a block diagram for describing a stress data generation circuit associated with an data accumulation process according to an aspect, and FIG. 12 is a block diagram for describing a data counting method that may be to implement a data accumulation process according to an aspect.

As illustrated in FIG. 8, a stress data generator 121, a data processor 125, a first memory 127, and a second memory 128 may be provided for a data accumulation process in accordance with some aspects of the disclosure. In one aspect, the stress data generator 121, the data processor 125, the first memory 127, and the second memory 128 may be integral to the timing controller 120.

The stress data generator 121 may generate stress data for predicting the characteristics (e.g., the amount of deterioration) of elements such as the organic light emitting diode OLED and the driving transistor DT based on an input data signal DATA.

The data processor 125 may operate in association with the stress data generator 121, the first memory 127, and the second memory 128 and be configured to read data, restore data, accumulate data, and compress data. In one aspect, the data processor 125 may include a data restorer 122 configured to restore data, a data accumulator 123 configured to accumulate data, and a data compressor 124 configured to compress data. Hereinafter, an example in which the data restorer 122 and the data compressor 124 compress and restore data based on a 2:1 compression algorithm will be described, but the aspect is not limited thereto.

The data processor 125 may configure the first memory 127 store stress data in an uncompressed state. The first memory 127 may be a volatile memory, for example, a DDR memory, which may temporarily maintain stored data only when the display device is turned on.

The data processor 125 may configure the second memory 128 may store accumulated stress data in a compressed state. The second memory 128 may be a non-volatile memory, for example, a NAND memory having a much larger storage capacity than a DDR memory, which may continuously maintain stored data even when the display device is turned off.

As illustrated in FIG. 9, the data accumulation compensation method according to the aspect may be include reading stress data (e.g., a DDR Read) operation at step S110, generating stress (Stress data generation) at step S120, accumulating the stress data (ACC) at step S130, determining whether a capacity of the accumulated stress data exceeds memory allocation amount (Memory Amount Excess?) at step S140, temporarily storing the accumulated stress data (DDR Write) at step S150, and backing up the stress data at step S160. Hereinafter, the data accumulation compensation method according to the aspect will be described in detail with reference to FIGS. 9 to 12 to aid in understanding of the data accumulation compensation method according to the aspect.

At step S110, the data accumulation method may read the sum of current accumulated stress data from the first memory 127 into the data processor 125. For example, step S110 may include instructions for reading the sum of stress data stored in the first memory 127, and such data is stored in the first memory 127 after operation for a predetermined period of time, and thus the step S110 may not be executed during initial operation.

At step S120, the data accumulation method may control the stress data generator 121 to generate stress data. In some aspects, the stress data generator 121 may generate stress data corresponding to an input data signal DATA provided by the data processor 125.

The stress data generator 121 may be implemented to generate stress data corresponding to the input data signal DATA based on a first circuit 121a as shown in FIG. 11. In some aspects, the first circuit 121a may arithmetically generate stress data corresponding to gray-level information of the data signal DATA based on the algorithm thereof and output the stress data.

In addition, the stress data generator 121 may be implemented to generate stress data corresponding to the input data signal DATA based on the first circuit 121a and a second circuit 121b as illustrated in FIG. 11. In some aspects, the second circuit 121b may provide the first circuit 121a with a unique characteristic value for each element constituting the panel or a reference value (or sensed value) according to a temperature change for each element of the display panel. In addition, the first circuit 121a may arithmetically generate stress data corresponding to gray-level information of the data signal DATA and a change in characteristics of the panel based on the algorithm thereof and information provided by the second circuit 121b. In some aspects, the second circuit 121b may be configured as a lookup table that is composed of data provided through various experiments.

At step S130, the data accumulation method may accumulate and count the stress data corresponding to the gray-level information of the input data signal DATA. The accumulating the stress data at step S130 may be performed at predetermined intervals (e.g., at least 1 frame) or at intervals set by the user. The accumulating the stress data of step S130 may be performed by the stress data generator 121 and the data processor 125.

The data processor 125 may accumulate stress data through a block-by-block counting (BLS) method, as shown in Option 1 of FIG. 12. Further, the data processor 125 may accumulate stress data through a 1-line counting method, as shown in Option 2 of FIG. 12. In addition, the data processor 125 may accumulate stress data through an n-line counting (n being an integer equal to or greater than 2) method, as shown in Option 3 of FIG. 12. Further, the data processor 125 may accumulate stress data through a frame counting method, as shown in Option 4 of FIG. 12.

At step S140, the data accumulation method may determine whether a capacity of the accumulated stress data exceeds a an allocated memory threshold. For example, the data processor 125 may the capacity of stress data that is currently accumulated and counted exceeds an allocated memory threshold, which is set internally. In one aspect, the memory allocation amount is based on a capacity allocated to the first memory 127, but the allocated memory threshold may be based on a capacity set by the operator or the user in the first memory 127. The data processor 125 may check whether the capacity of the accumulated stress data exceeds the memory allocation amount continuously or at predetermined intervals while accumulating and counting stress data corresponding to the gray-level of the data signal DATA.

At step S150, the data accumulation method may record (e.g., write) the accumulated stress data into the first memory 127. The recording the stress data for temporary storage may be performed when it is determined that the capacity of the stress data does not exceed the memory allocation amount (N).

Although the step recording the stress data for temporary storage is performed by the data processor 125 as shown in FIG. 10, the stress data is not recorded in the first memory 127 in a compressed state. Accordingly, the accumulated stress data may be accumulated by the data accumulator 123 included in the data processor 125 and then recorded in the first memory 127 in an uncompressed state. Accordingly, the sum of the currently accumulated stress data may be temporarily stored in the first memory 127 in an uncompressed state.

In FIG. 10, since the process of reading or writing the accumulated stress data from or to the first memory 127 corresponds to a process of passing the accumulated stress data through the data accumulator 123 included in the data processor 125 without using a compression algorithm, it is noted that the process is represented as a bypass. That is, in the step S150, only the data accumulator 123 included in the data processor 125 is activated, and the data restorer 122 (decoder) and the data compressor 124 (encoder) may be deactivated.

At step S160, the data accumulation method may back up the accumulated stress data into a non-volatile memory. The backing up the stress data may be performed in response to a flag on signal that is generated when the capacity of the accumulated stress data exceeds the allocated memory threshold (Y).

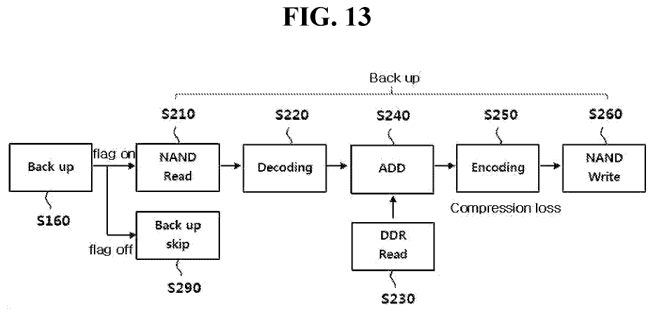

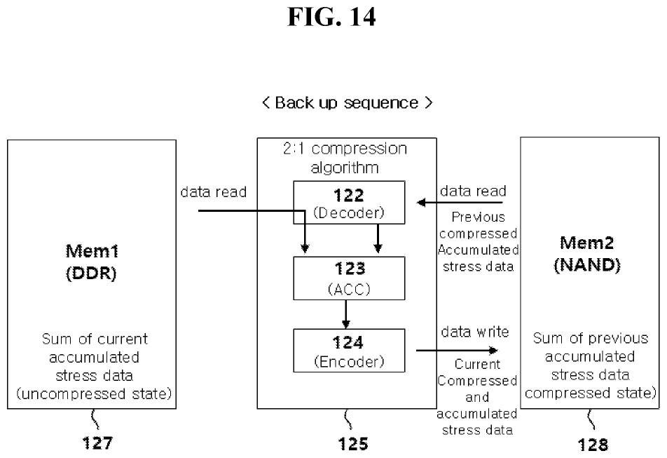

FIG. 13 is a flowchart for describing the data backup process in the data accumulation compensation method according to the aspect, and FIG. 14 is a data backup sequence showing the data backup process according to in connection with a circuit in accordance with some aspects of the disclosure.

As illustrated in FIG. 13, the data backup process in the data accumulation compensation method according to the aspect may be performed when the flag on signal is generated and may be skipped without being performed if a flag off signal is generated at step S290 (e.g., a Backup skip).

The data backup process according to the aspect may comprise reading previous accumulated stress data (NAND Read) at step S210, decompressing the previous accumulated stress data at step S220, reading current accumulated stress data (DDR Read) at step S230, integrating the accumulated stress data at step S240, compressing the accumulated stress data at step S50, and recording (e.g., writing) the accumulated stress data into permanent storage (NAND write) at step S260. Hereinafter, the data backup process according to the aspect will be described in detail with reference to FIGS. 13 and 14 to aid in understanding of the data backup process.

At step S210 the data accumulation method may read the sum of previous accumulated stress data from the second memory 128 into the data processor 125. Here, since the sum of previous accumulated stress data is in a compressed state, it may be represented as the sum of previous compressed accumulated stress data as illustrated in FIG. 14.

At step S220, the data accumulation method may decompress the sum of the previous accumulated stress data in a compressed state read from the second memory 128. The decompression may be performed by the data restorer 122 (decoder) included in the data processor 125. The data restorer 122 may decompress the sum of the previous accumulated stress data in a compressed state and then transmit the decompressed sum of the previous accumulated stress data to the data accumulator 123.

At step S230, the data accumulation method may read the sum of current accumulated stress data from the first memory 127. The step S230 of reading the current accumulated stress data may be performed by the data processor 125, and the read current accumulated stress data may be transmitted to the data accumulator 123 included in the data processor 125.

At step S240, the data accumulation method may integrate the sum of the current accumulated stress data and the sum of the previous accumulated stress data. The integrating the accumulated stress data may be performed by the data accumulator 123. The data accumulator 123 may adopt a method of adding the sum of the current accumulated stress data to the sum of the previous accumulated stress data or a method of further adding other environmental variable values.

At step S250), the data accumulation method may compress the sum of the integrated accumulated stress data. The compression may be performed by the data compressor 124 (encoder) included in the data processor 125. The data compressor 124 may compress the sum of the accumulated stress data based on, for example, a 2:1 compression algorithm. Compression loss due to compression may occur only in the step S250 of performing compression.

In another example of step S230, the current accumulated stress data may be before exceeding the allocation amount set in the first memory 127, or even a certain amount of current accumulated stress data accumulated after exceeding the allocation amount may be read. For example, if the allocation amount set in the first memory 127 is 16 bits and 18-bit current accumulated stress data are to be stored, (1) a method of reading only current accumulated stress data corresponding to 16 bits (compression storage method without excess) or (2) a method of reading all of the current accumulated stress data corresponding to 18 bits (compression storage method including excess) may be adopted.

In the above two methods, the compression method includes stopping data accumulation when the capacity of the current accumulated stress data is expected to exceed the allocated amount set in the first memory 127. In addition, the compression method may include continuing data accumulation when the capacity of the current accumulated stress data is expected to exceed the allocated amount set in the first memory 127. In this case, when the capacity of the current accumulated stress data exceeds the allocation amount, the excess is permitted to be compressed and stored.

At step S260, the data accumulation method may record the sum of the accumulated stress data in a compressed state in the second memory 128 for permanent storage. The recording the accumulated stress data for permanent storage is performed by the data processor 125 and the second memory 128 in association as illustrated in FIG. 14, and recorded in the second memory 128 in a compressed state.

Accordingly, the accumulated stress data may be updated in the form of a combination of the previous accumulated stress data and the current accumulated stress data in the second memory 128 in a compressed state. Accordingly, the sum of the current accumulated stress data may be permanently stored in the second memory 128 in a compressed state. In this case, since the sum of the current accumulated stress data is in a compressed state, it may be represented as the sum of the currently compressed accumulated stress data as illustrated in FIG. 14.

Meanwhile, it should be noted that the expression of permanent storage in the above description corresponds to the non-volatile storage capability of the second memory 128. If the display device is turned off in the current state, the sum of current accumulated stress data stored in the second memory 128 may be maintained in a compressed state. However, when the next backup process proceeds through a series of processes after the display device is turned on, the sum of the current accumulated stress data will be updated. In some aspects, the permanent storage in the second memory 128 corresponds to storage until the next backup process is performed.

Although the backup process performed when the capacity of accumulated stress data exceeds the internally set memory allocation amount has been described, this may be equally applied to a backup process performed when the display device is turned off.

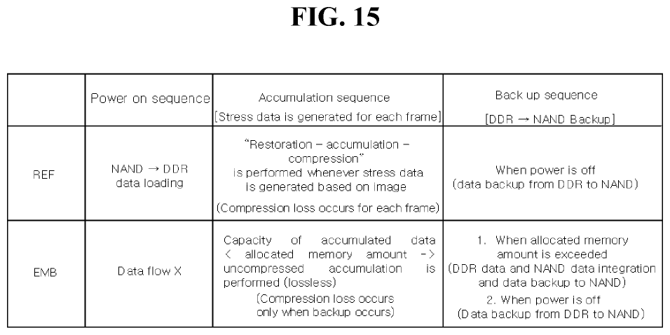

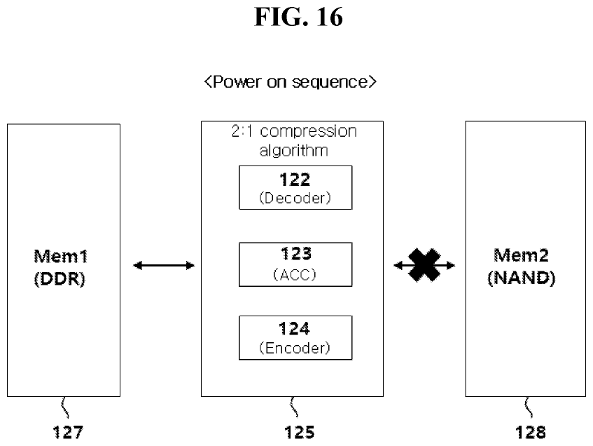

FIG. 15 is a diagram for describing differences between a data accumulation compensation method according to a comparative example and the data accumulation compensation method according to the aspect, and FIG. 16 is a diagram showing a flow of a power-on sequence changed by the data accumulation compensation method according to the aspect.

As illustrated in FIGS. 15 and 16, the data accumulation compensation method according to the aspect (EMB) has characteristics better than those of the comparative example (REF) in (1) power on sequence, (2) accumulation sequence, and (3) backup sequence, which is described as follows.

(1) Power on Sequence—when the Display Device is Turned on

In the aspect (EMB), when the display device is turned on, a process of storing currently generated stress data in the first memory 127 may be performed first. Accordingly, a process of exchanging data between the first memory 127 and the second memory 128 (NAND=>DDR data loading) as in the comparative example (REF) may be omitted (Data flow X).

A state after the display device is turned on may correspond to initial operation. This state may not correspond to a case where the internally set memory allocation amount is exceeded. Accordingly, it is not necessary to read the sum of previous accumulated stress data from the second memory 128 in the aspect (EMB).

Therefore, compared to the comparative example (REF), the aspect (EMB) may reduce requirements for generating a sequence that occurs unnecessarily during the initial operation of the display device, enabling rapid operation of the display device (e.g., advancing driving timing) and reducing a power consumption rate.

(2) Accumulation Sequence—when Stress Data is Accumulated

The aspect (EMB) may continue to perform non-compressed accumulation (lossless) in the case of “capacity of accumulated data<allocated memory amount.” As a result, in the aspect (EMB), compression loss due to compression and storage may occur when a backup occurs, such when the allocated memory threshold amount is exceeded. On the other hand, in the comparative example (REF), “restoration-accumulation-compression” should be performed when stress data is generated based on an image. As a result, in the comparative example (REF), compression loss may occur due to compression and storage for each frame.

Therefore, the aspect (EMB) may improve the compensation performance of the display panel by minimizing a rate of data loss (e.g., minimizing a risk of compression loss accumulation) in the method of accumulating and storing stress data, as compared to the comparative example (REF).

(3) Backup Sequence—when Stress Data is Backed Up

The aspect (EMB) may perform data backup “when an allocated memory amount is exceeded or when power is turned off. As a result, since accumulation of stress data is not performed for a long time and data backup is performed when the allocated memory amount is exceeded, the amount of data to be processed during power off may be reduced. On the other hand, in the comparative example (REF), data backup may be performed only when power is off. As a result, there is a large amount of data to be processed while powering off in the comparative example (REF), and thus it may take a long time to turn off the display device.

Therefore, the aspect (EMB) may reduce a time required for data backup compared to the comparative example (REF), decrease a time required to substantially turn off the display device, and reduce a power consumption rate.

The present disclosure has an effect of providing a data accumulation compensation method capable of improving compensation performance of a display panel by minimizing a risk of compression loss accumulation. In addition, the present disclosure has an effect of enabling rapid operation of a display device (advancing driving timing) by reducing requirements for generation of a sequence that occurs unnecessarily during data accumulation compensation. Further, the present disclosure has an effect of reducing a time required to substantially turn off the display device and decreasing a power consumption rate.

It will be apparent to those skilled in the art that various modifications and variations may be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A display device comprising:
a display panel configured to display an image:
a stress data generator configured to generate stress data corresponding to a data signal to be displayed on the display panel; and
a data processor configured to accumulate the stress data to obtain first stress data, store the first stress data in a first memory, wherein the data processor is configured to compress the first stress data when a size of the first stress data exceeds a memory threshold.

2. The display device of claim 1, wherein the data processor stores the first stress data in the first memory in an uncompressed state when the size of the first stress data does not exceed the memory threshold.

3. The display device of claim 1, wherein the data processor stores the first stress data in a second memory different from the first memory in a compressed state when the size of the first stress data exceeds the memory threshold.

4. The display device of claim 3, wherein the data processor includes:
a data restorer configured to decompress data stored in the second memory to obtain second stress data:
a data accumulator configured to obtain the first stress data, and integrate the second stress data and the first stress data to obtain third stress data; and
a data compressor configured to compress the third stress data.

5. The display device of claim 3, wherein the data processor is configured to:
decompress data in the second memory to obtain second stress data,
read the first stress data from the first memory,
integrate and compress the first stress data and the second stress data to obtain a third stress data, and
stores the third stress data in the second memory.

6. The display device of claim 5, wherein, when a size of the third stress data exceeds the memory threshold, the data processor is configured to read the third stress data while excluding an excess from the first memory.

7. The display device of claim 5, wherein, when a size of the third stress data exceeds the memory threshold, the data processor is configured to read the third stress data including an excess from the first memory.

8. A method of driving a display device, comprising:
generating stress data corresponding to a data signal to be displayed on a display panel:
storing first stress data obtained by accumulating the stress data in a first memory:
determining whether a capacity of the first stress data exceeds a memory threshold; and
compressing the first stress data when a size of the first stress data exceeds the memory threshold.

9. The method of claim 8, wherein the first stress data is stored in the first memory in an uncompressed state when the size of the first stress data does not exceed the memory threshold, and
wherein the first stress data is stored in a second memory different from the first memory in a compressed state when the capacity of the first stress data exceeds the memory threshold.

10. The method of claim 9, wherein, when the size of the first stress data exceeds the memory threshold, the first stress data excluding or including an excess is read from the first memory.

11. The display device of claim 3, wherein the first memory comprises a volatile memory and the second memory comprises a non-volatile memory.

12. The display device of claim 1, wherein the stress data generator is configured to generate the stress data for predicting the characteristics of at least one of a light emitting element and a transistor coupled to the light emitting element based on the data signal.

13. The display device of claim 12, wherein the stress data generator is configured to read gray information associated with the data signal and generate the stress data based on the gray information.

14. The display device of claim 12, wherein the stress data generator is configured to generate the stress data based on at least one temperature sensed within the display device.

15. The display device of claim 1, wherein the data processor and the stress data generator are included in a timing controller in the display device.
